(19) United States
(12) Patent Application Publication
(10) Pub. No.: US 2026/0005736 A1
(43) Pub. Date: Jan. 1, 2026

(54) BEAMFORMING CODEBOOK UPDATE IN A FOLDABLE DEVICE

(71) Applicant: QUALCOMM Incorporated, San Diego, CA (US)

(72) Inventors: Vasanthan RAGHAVAN, West Windsor Township, NJ (US); Yu-Chin OU, San Diego, CA (US)

(21) Appl. No.: 18/761,112

(22) Filed: Jul. 1, 2024

(51) Int. Cl. H04B 7/0456; H01Q 3/12; H04B 17/12; H04B 17/21

(52) U.S. Cl. CPC H04B 7/0482; H01Q 3/12; H04B 17/12; H04B 17/221

(57) ABSTRACT

Aspects relate to mechanisms for a UE to dynamically update and re-calibrate beamforming codebooks based on a current foldable state of the UE. The UE may include a first tile including a first antenna array and a second tile including a second antenna array. The UE may be capable of being configured in a plurality of different foldable states, each defined by a respective angular separation between the first tile and the second tile. The UE can further maintain a plurality of beamforming codebooks, each associated with a respective configured foldable state of the UE, and update a beamforming codebook of the plurality of beamforming codebooks based on the current foldable state.

### TECHNICAL FIELD

The technology discussed below relates generally to wireless communication systems, and more particularly, to beamforming codebooks in user equipment (UE) with foldable properties/states.

### INTRODUCTION

Wireless communication systems, such as those specified under fifth generation (5G) systems, referred to as New Radio (NR) systems, sixth generation (6G) systems, and other future generations, a network entity and user equipment (UE) may utilize beamforming to compensate for high path loss and short range. Beamforming is a signal processing technique used with an antenna array module for directional signal transmission and/or reception. Each antenna in the antenna array module transmits a signal that is combined with other signals of other antennas of the same array in such a way that signals at particular angles experience constructive interference while others experience destructive interference.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for wireless communication at a user equipment (UE) includes a plurality of antenna arrays configured for beamforming, one or more memories and one or more processors coupled to the one or more memories and the plurality of antenna arrays. The plurality of antenna arrays includes a first antenna array and a second antenna array coupled to the first antenna array. The one or more processors can be configured to identify a current foldable state of a plurality of foldable states of the UE. Each of the plurality of foldable states is defined by a respective angle separation between a first tile of the UE and a second tile of the UE. The first tile includes the first antenna array and the second tile includes the second antenna array. The one or more processors can further be configured to update a beamforming codebook of a plurality of beamforming codebooks of the UE based on the current foldable state to produce an updated beamforming codebook. Each of the plurality of beamforming codebooks is associated with a respective configured foldable state of the plurality of foldable states. The one or more processors is further configured to communicate with a network entity using the updated beamforming codebook.

Another example provides a method operable at a user equipment (UE). The method includes identifying a current foldable state of a plurality of foldable states of the UE. Each of the plurality of foldable states is defined by a respective angle separation between a first tile of the UE and a second tile of the UE. The first tile includes a first antenna array and the second tile includes a second antenna array coupled to the first antenna array, in which the first antenna array and the second antenna array are configured for beamforming. The method further includes updating a beamforming codebook of a plurality of beamforming codebooks of the UE based on the current foldable state to produce an updated beamforming codebook. Each of the plurality of beamforming codebooks is associated with a respective configured foldable state of the plurality of foldable states. The method further includes communicating with a network entity using the updated beamforming codebook.

Another example provides an apparatus including means for identifying a current foldable state of a plurality of foldable states of the UE. Each of the plurality of foldable states is defined by a respective angle separation between a first tile of the UE and a second tile of the UE. The first tile includes a first antenna array and the second tile includes a second antenna array coupled to the first antenna array, in which the first antenna array and the second antenna array are configured for beamforming. The apparatus further includes means for updating a beamforming codebook of a plurality of beamforming codebooks of the UE based on the current foldable state to produce an updated beamforming codebook. Each of the plurality of beamforming codebooks is associated with a respective configured foldable state of the plurality of foldable states. The apparatus further includes means for communicating with a network entity using the updated beamforming codebook.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram providing a high-level illustration of one example of a configuration of a disaggregated base station according to some aspects.

FIG. 4 illustrates an example of a wireless communication system supporting beamforming between a network entity and a UE device according to some aspects.

FIG. 5 is a diagram illustrating an example of a transmitter architecture for beamforming according to some aspects.

FIGS. 6A and 6B are diagrams illustrating examples of foldable states of a user equipment (UE) according to some aspects.

FIGS. 7A and 7B are diagrams illustrating other examples of foldable states of a UE according to some aspects.

FIG. 8 is a diagram illustrating an example of a UE configured to update a beamforming codebook based on the foldable state of the UE according to some aspects.

FIG. 9 is a signaling diagram illustrating exemplary signaling for updating a beamforming codebook based on a foldable state of UE according to some aspects.

FIG. 10 is a block diagram illustrating an example of a hardware implementation for a UE employing a processing system according to some aspects.

FIG. 11 is a flow chart illustrating an exemplary process for a UE to update a beamforming codebook based on a foldable state of the UE according to some aspects.

FIG. 12 is a flow chart illustrating another exemplary process for a UE to update a beamforming codebook based on a foldable state of the UE according to some aspects.

FIG. 13 is a block diagram illustrating an example of a hardware implementation for a network entity employing a processing system according to some aspects.

FIG. 14 is a flow chart illustrating an exemplary process for a network entity to facilitate updating a beamforming codebook of a UE based on a foldable state of the UE according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

In millimeter wave systems, multiple antennas of an antenna module, and multiple antenna modules (e.g., antenna arrays), are used at the network entity and the user equipment (UE) to facilitate beamforming, which is used to improve the link margin. As the number of antenna elements increases, the channel estimation overhead and complexity increases. As a result, ideal beamforming between the transmitter and receiver may be difficult to achieve. Therefore, codebook-based beamforming has been introduced to eliminate the overhead. A beamforming codebook is a collection of beamforming vectors, each representing a particular beam covering a specific direction in space (e.g., azimuth and elevation regions over the coverage region of the antenna array). Each beamforming vector includes a set of beam weights (e.g., respective antenna weights (e.g., phases and/or amplitudes) applied to each antenna element of the antenna arrays) whose linear combination forms the particular beam. For example, a beamforming vector may include an N×K matrix, where N is the number of antenna elements and K is the number of beams.

Foldable phones have become common in the 5G ecosystem, with increased traction expected in 6G. In addition, 6G is expected to support both FR2 (e.g., 24.25-52.6 GHz) and FR3 (e.g., 7.125-24.25 GHz) in many geographical areas. Due to the nature of foldable phones, the width of the phone may be extremely thin (e.g., ultra-thin designs). As a result, the antenna modules that need to be fitted within the edges of both foldable as well as non-foldable phones are expected to be thin or have reduced thickness. Fitting a dual-polarized antenna module/array in such a narrow thickness may be difficult for FR2, let alone for FR3. In such designs, split antenna array architectures may be introduced to improve performance. However, not all of these split antenna array architectures may produce good performance with pre-stored beamforming codebooks and calibration mechanisms.

Various aspects are related to mechanisms for a UE to dynamically update and re-calibrate pre-stored beamforming codebooks based on a current foldable state of the UE. For example, a UE may maintain a plurality of beamforming codebooks, each associated with a particular configured (e.g., pre-configured) foldable state of the UE. A foldable state may be defined, for example, by an angular separation between tiles/panels of the UE. Here, each tile/panel includes a respective antenna array of a split antenna architecture. One foldable state may correspond to a state in which the UE is completely closed, while another foldable state may correspond to a state in which the UE is completely open. The UE may update one of the pre-stored beamforming codebooks based on the current foldable state to produce an updated beamforming codebook and communicate with a network entity using the updated beamforming codebook.

In some examples, the UE may compare the current foldable state to each of the configured foldable states and perform an update to one of the beamforming codebooks when the current beamforming state is different than any of the configured foldable states (e.g., none of the configured foldable states match the current foldable state). In some examples, the UE may select a pre-stored beamforming codebook, analyze a current performance of the selected beamforming codebook for the current foldable state, and then update the selected beamforming codebook when the current performance for the current foldable state fails to meet an expected or requisite performance. For example, the selected beamforming codebook may be associated with an angular separation nearest or closest to the angular separation of the current foldable state. The expected/current performance may be based, for example, on a theoretical array gain based on the number of antenna elements in the antenna arrays when the beams from each antenna array are steered towards a boresight direction. For example, the expected/current performance may be based on a set of beam weights in the selected beamforming codebook associated with a set of beam directions (e.g., boresight directions) from each of the tiles/panels (e.g., from the antenna arrays within each of the tiles/panels).

In some examples, the UE may determine a set of co-phasing factors indicating respective phase deviations across the antenna arrays in the current foldable state and modify one or more beam weights of the selected pre-stored codebook using the set of co-phasing factors to produce the updated beamforming codebook. In some examples, the set of co-phasing factors may be determined through communication of uplink and/or downlink reference signals with the network entity. For example, the UE may transmit a request for a codebook update to the network entity. The network entity may then send a grant of uplink and/or downlink reference signals to the UE to perform the codebook update. In some examples, the UE may perform measurements (e.g., signal strength, channel impulse response, and/or other suitable measurements) of received downlink reference signals based on the grant to determine the set of co-phasing factors. In other examples, the UE may transmit uplink reference signals based on the grant (grant issued by the network entity) to the network entity and receive feedback from the network entity based on the uplink reference signal measurements performed by the network entity. For example, the feedback may include the co-phasing factors or may include the updated beam weights to be applied to the selected beamforming codebook.

In some examples, the beamforming codebooks may be designed using downlink reference signals. In many UE configurations, there may be circuit mismatches (e.g., radio frequency integrated circuit chip level mismatches) between the uplink and downlink that may be accommodated in the UE. For example, if a beamforming codebook includes a particular beam weight (phase) for a certain downlink beam, the UE may include a lookup table that indicates the corresponding beam weight (phase) to produce the same beam on the uplink. However, the lookup table may not be available in its entirety (e.g., for all phases of all beams), especially after performing an update to a beamforming codebook based on the current foldable state. Therefore, a re-calibration of the updated beamforming codebook may be performed after updating to account for the uplink-downlink RFIC chip level mismatches in the UE. Similarly, if the updated beamforming codebook is generated based on uplink reference signals, a re-calibration of that updated beamforming codebook for the downlink may be performed. Re-calibration may involve measurements of downlink and/or uplink reference signals to make the calibration adjustments to be filled in the lookup table.

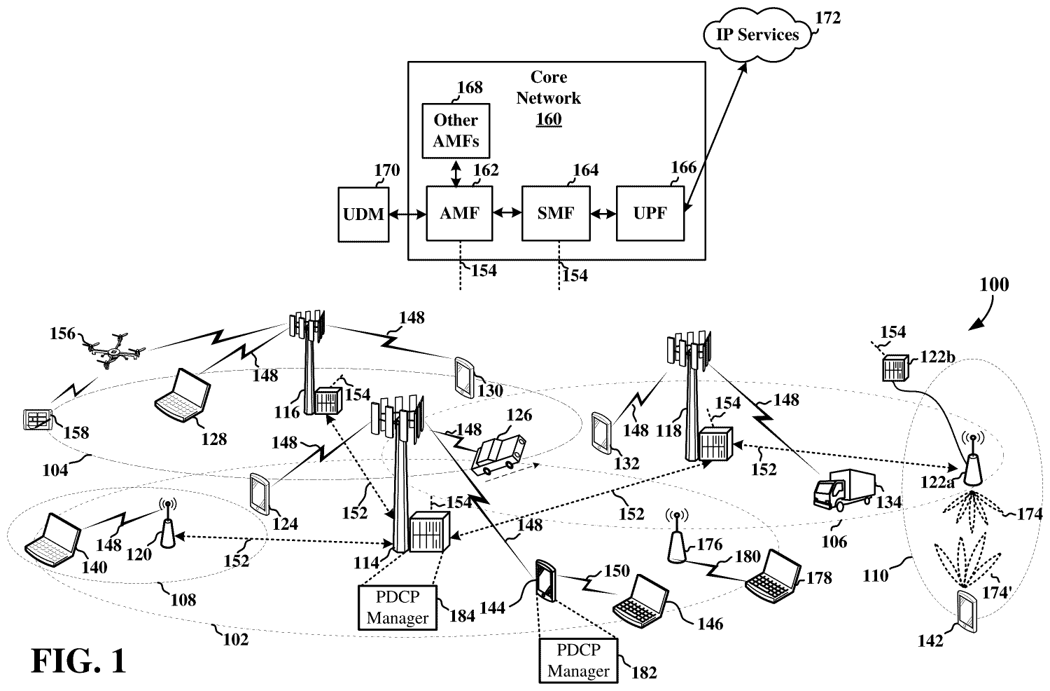

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

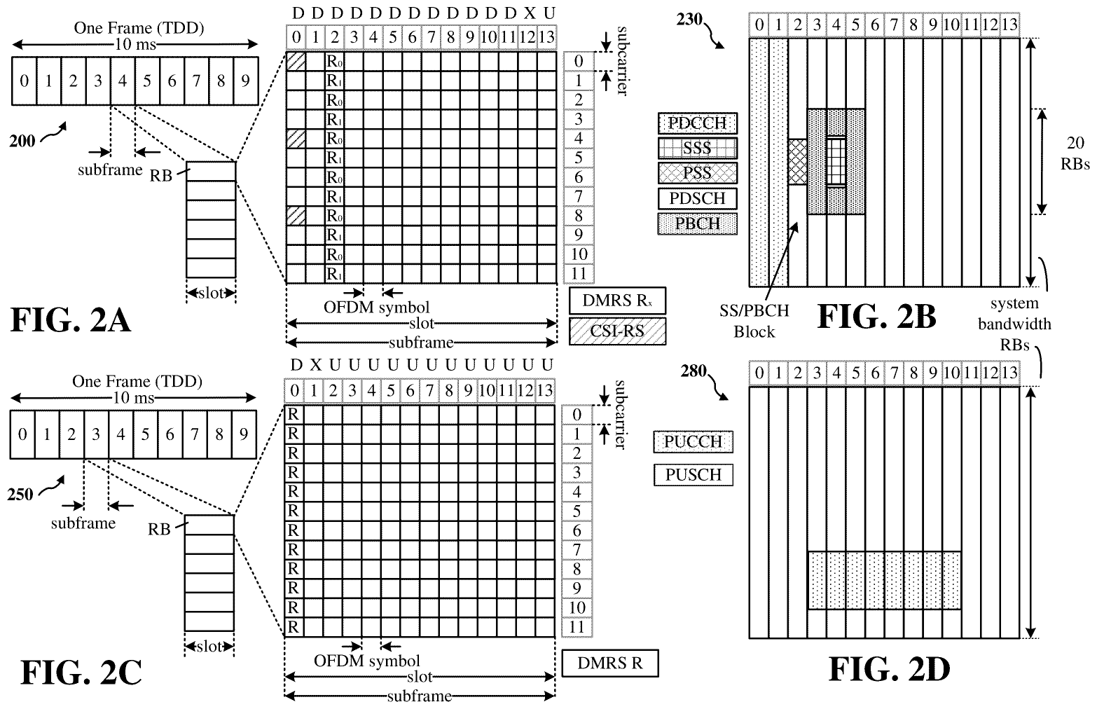

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

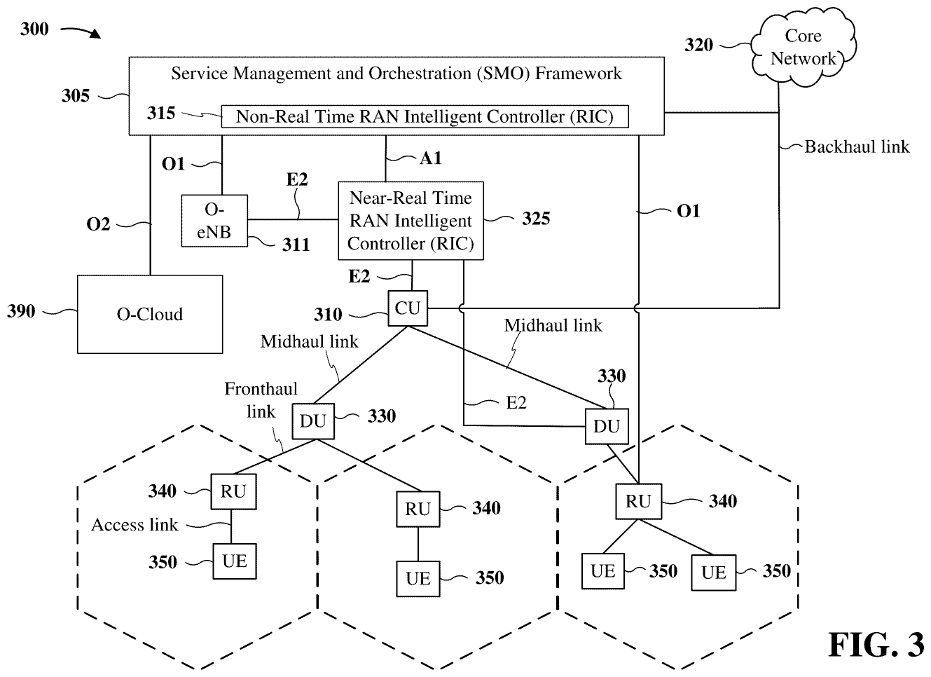

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E3 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O3 interface). Such virtualized network elements can include, but are not limited to, CUs 310, DUs 330, RUs 340 and Near-RT RICs 325. In some implementations, the SMO Framework 305 can communicate with a hardware aspect of a 5G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E3 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

Beamforming is a signal processing technique that may be used at the transmitter and/or receiver to shape or steer an antenna beam (e.g., a transmit beam or receive beam) along a spatial path between the transmitter and the receiver. A network entity (e.g., gNB) may generally be capable of communicating with UEs using transmit beams (e.g., downlink transmit beams) of varying beam widths. The UE may further be configured to utilize one or more downlink receive beams to receive signals from the network entity.

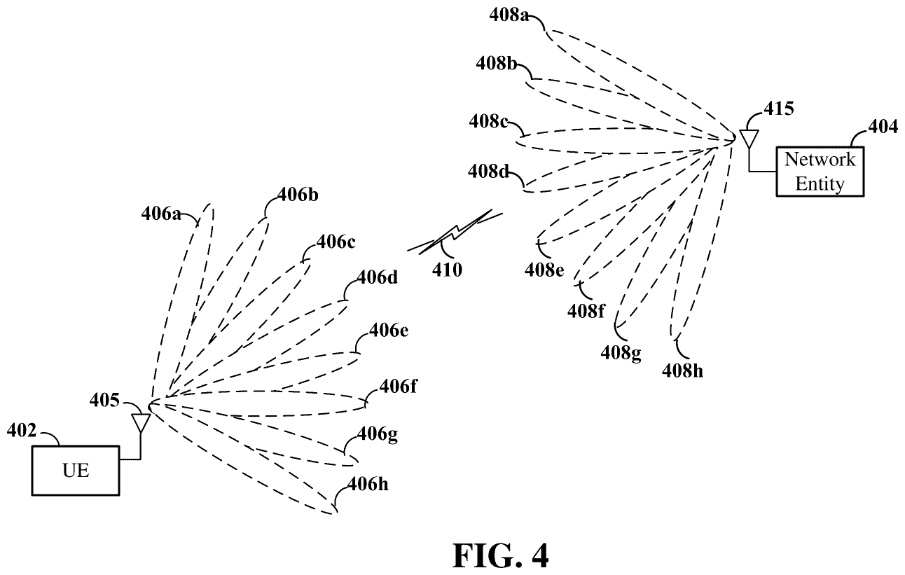

FIG. 4 is a diagram illustrating communication between a network entity 404 and a UE 402 using beamformed signals according to some aspects. The network entity 404 may be any of the network entities (e.g., gNBs) or NTN entities illustrated in FIGS. 1 and/or 2, and the UE 402 may be any of the UEs illustrated in FIGS. 1 and/or 2.

In the example shown in FIG. 4, the network entity 404 is configured to generate a plurality of beams 408a-408h, each associated with a different beam direction. In addition, the UE 402 is configured to generate a plurality of beams 406a-406h, each associated with a different beam direction. The network entity 404 and UE 402 may select one or more beams 408a-408h on the network entity 404 and one or more beams 406a-406h on the UE 402 for communication of uplink and downlink signals therebetween using a downlink beam management scheme and/or an uplink beam management scheme.

Beamforming may be achieved by combining the signals communicated via, for example, antennas 405 or 415 (e.g., antenna elements of an antenna array) such that some of the signals experience constructive interference while others experience destructive interference. To create the desired constructive/destructive interference, the UE 402 or network entity 404 may apply amplitude and/or phase offsets to signals transmitted or received from the antenna elements 405 or 415 associated with the UE 402 or network entity 404. In some examples, the antenna elements may be mapped to antenna ports for generation of beams. Here, the term antenna port refers to a logical port (e.g., a beam) over which a signal (e.g., a data stream or layer) may be transmitted. In an example of a base station, an antenna array may include 128 antenna elements (e.g., within a 16×8 array) that may be mapped to 32 antenna ports by an 8×1 combiner.

In an example of a downlink beam management scheme for selection of downlink beams, the network entity 404 may be configured to sweep or transmit on each of a plurality of downlink transmit beams 408a-408h during one or more synchronization slots. For example, the network entity 404 may transmit a reference signal, such as an SSB or CSI-RS, on each beam in the different beam directions during the synchronization slot. Transmission of the beam reference signals may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). It should be noted that while some beams are illustrated as adjacent to one another, such an arrangement may be different in different aspects. For example, downlink transmit beams 408a-408h transmitted during a same symbol may not be adjacent to one another. In some examples, the network entity 404 may transmit more or less beams distributed in all directions (e.g., 360 degrees).

In addition, the UE 402 is configured to receive the downlink beam reference signals on a plurality of downlink receive beams 406a-406h. In some examples, the UE 402 searches for and identifies each of the downlink transmit beams 408a-408h based on the beam reference signals. The UE 402 then performs beam measurements (e.g., RSRP, SINR, reference signal received quality (RSRQ), etc.) on the beam reference signals on each of the downlink receive beams 406a-406h to determine the respective beam quality of each of the downlink transmit beams 408a-408h as measured on each of the downlink receive beams 406a-406h.

The UE 402 can generate and transmit an L1 measurement report, including the respective beam index (beam identifier (ID)) and beam measurement of one or more of the downlink transmit beam 408a-408h on one or more of the downlink receive beams 406a-406h to the network entity 404. The network entity 404 may then select one or more downlink transmit beams on which to transmit unicast downlink control information and/or user data traffic to the UE 402. In some examples, the selected downlink transmit beam(s) have the highest gain from the beam measurement report. In some examples, the UE 402 can further identify the downlink transmit beams selected by the network entity from the beam measurements. Transmission of the beam measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The network entity 404 or the UE 402 may further select a corresponding downlink receive beam on the UE 402 for each selected serving downlink transmit beam to form a respective downlink beam pair link (BPL) for each selected serving downlink transmit beam. For example, the UE 402 can utilize the beam measurements to select the corresponding downlink receive beam for each serving downlink transmit beam. In some examples, the selected downlink receive beam to pair with a particular downlink transmit beam may have the highest gain for that particular downlink transmit beam.

In one example, a single downlink transmit beam (e.g., beam 408d) on the network entity 404 and a single downlink receive beam (e.g., beam 406d) on the UE may form a single downlink BPL used for communication between the network entity 404 and the UE 402. In another example, multiple downlink transmit beams (e.g., beams 408c, 408d, and 408e) on the network entity 404 and a single downlink receive beam (e.g., beam 406d) on the UE 402 may form respective downlink BPLs used for communication between the network entity 404 and the UE 402. In another example, multiple downlink transmit beams (e.g., beams 408c, 408d, and 408e) on the network entity 404 and multiple downlink receive beams (e.g., beams 406d and 406e) on the UE 402 may form multiple downlink BPLs used for communication between the network entity 404 and the UE 402. In this example, a first downlink BPL may include downlink transmit beam 408c and downlink receive beam 406d, a second downlink BPL may include downlink transmit beam 408d and downlink receive beam 406d, and a third downlink BPL may include downlink transmit beam 408e and downlink receive beam 406e.

When the channel is reciprocal, the above-described downlink beam management scheme may also be used to select one or more uplink BPLs for uplink communication from the UE 402 to the network entity 404. For example, the downlink BPL formed of beams 406d and 408d may also serve as an uplink BPL. Here, beam 406d is utilized as an uplink transmit beam, while beam 408d is utilized as an uplink receive beam.

In an example of an uplink beam management scheme, the UE 402 may be configured to sweep or transmit on each of a plurality of uplink transmit beams 406a-406h. For example, the UE 402 may transmit an SRS on each beam in the different beam directions. In addition, the network entity 404 may be configured to receive the uplink beam reference signals on a plurality of uplink receive beams 408a-408h. In some examples, the network entity 404 searches for and identifies each of the uplink transmit beams 406a-406h based on the beam reference signals. The network entity 404 then performs beam measurements (e.g., RSRP, SINR, RSRQ, etc.) on the beam reference signals on each of the uplink receive beams 408a-408h to determine the respective beam quality of each of the uplink transmit beams 406a-406h as measured on each of the uplink receive beams 408a-408h.

The network entity 404 may then select one or more uplink transmit beams on which the UE 402 will transmit unicast downlink control information and/or user data traffic to the network entity 404. In some examples, the selected uplink transmit beam(s) have the highest gain. The network entity 404 may further select a corresponding uplink receive beam on the network entity 404 for each selected serving uplink transmit beam to form a respective uplink beam pair link (BPL) for each selected serving uplink transmit beam. For example, the network entity 404 can utilize the uplink beam measurements to select the corresponding uplink receive beam for each serving uplink transmit beam. In some examples, the selected uplink receive beam to pair with a particular uplink transmit beam may have the highest gain for that particular uplink transmit beam.

The network entity 404 may then notify the UE 402 of the selected uplink transmit beams. For example, the network entity 404 may provide the SRS resource identifiers (SRIs) identifying the SRSs transmitted on the selected uplink transmit beams. In some examples, the network entity 404 may apply each selected uplink transmit beam (and corresponding uplink receive beam) to an uplink signal (e.g., PUCCH, PUSCH, etc.) and transmit the respective SRIs associated with the selected uplink transmit beams applied to each uplink signal to the UE 402. When the channel is reciprocal, the above-described uplink beam management scheme may also be used to select one or more downlink BPLs for downlink communication from the network entity 404 to the UE 402. For example, the uplink BPLs may also be utilized as downlink BPLs.

The available uplink and downlink beams may be defined through one or more beamforming codebooks. For example, a beamforming codebook may include a collection of beamforming vectors, each representing a particular downlink/uplink beam covering a specific direction in space (e.g., azimuth and elevation). Each beamforming vector includes a set of beam weights (e.g., respective antenna weights (e.g., phases) applied to each antenna element of the antenna arrays) whose linear combination forms the particular beam. For example, a beamforming vector may include an N×K matrix, where N is the number of antenna elements and K is the number of beams. Depending on the direction (downlink or uplink) that the beam weights are determined for, a calibration lookup table may further be defined to indicate the phase updates to apply to a particular beamforming vector for the reverse link. For example, if the beamforming codebook is defined based on measurements of downlink reference signals, the calibration lookup table may provide the phase updates to apply to each beamforming vector to achieve the same beam in the uplink. Such phase updates may be needed, for example, due to RF circuit mismatches between the uplink and downlink.

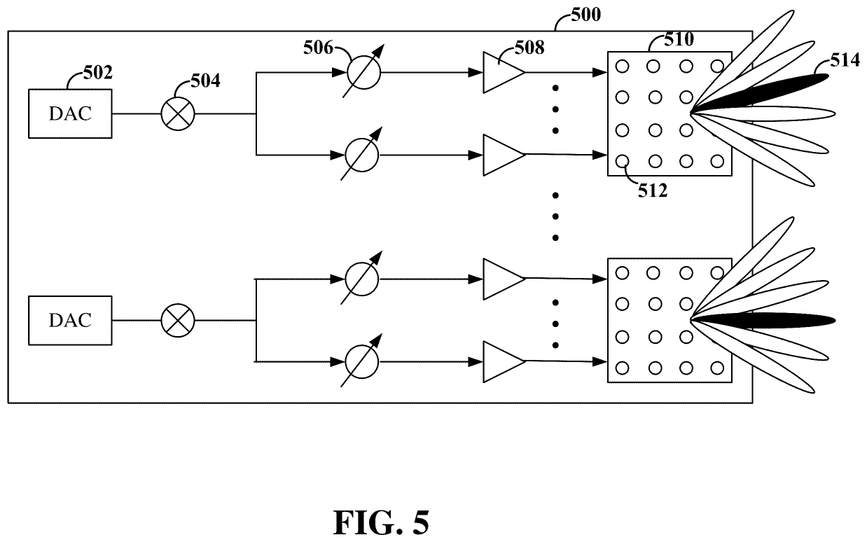

FIG. 5 is a diagram illustrating an example of a transmitter architecture 500 for beamforming according to some aspects. The transmitter architecture 500 may include, for example, one or more antenna modules (arrays) 510, each including a plurality of antenna elements for communicating respective beamformed radio frequency (RF) signals. The transmitter architecture 500 may further include for example, digital-to-analog converters (DACs) 502, each configured to convert a respective digital signal to a corresponding analog signal. The resulting analog signals may be up-converted to radio frequency (RF) signals by respective mixers 504. The RF signals may then be input to respective analog phase-shifters 506 to produce respective analog beamformed signals, each corresponding to a desired beam 514 for each of the antenna modules 510. The analog beamformed signals may be amplified by respective power amplifiers 508 to produce respective amplified beamformed signals for transmission via the respective antenna modules 510.

As foldable phones have become more common, different split antenna array architectures have been proposed to maintain performance, especially in mmWave frequencies, such as FR2 and FR3. Since the width of the phone in such foldable designs may be extremely thin (e.g., an ultra-thin design with a thickness at the edge of 2 or 3 mm), fitting a dual-polarized antenna module/array in such a narrow thickness may be difficult. Therefore, split antenna architectures including two single-polarized antenna arrays that may be combined across different tiles/panels of the foldable phone to produce a dual-polarized antenna array may be utilized to improve performance.

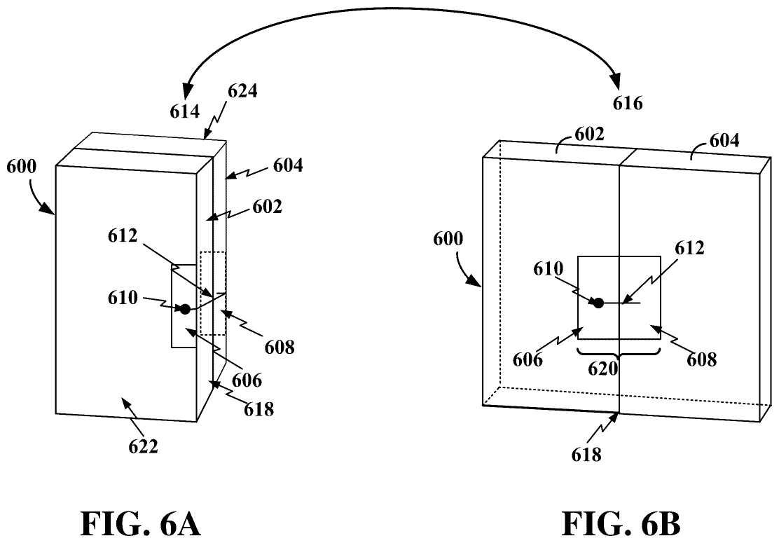

FIGS. 6A and 6B are diagrams illustrating examples of foldable states of a user equipment (UE) according to some aspects. The UE 600 may correspond to any of the UEs or other suitable devices illustrated in FIGS. 1, 3, 4 and/or 5. In addition, the UE 600 may be a 5G wireless communication device configured to transmit and receive mm Wave frequencies using antenna modules/antenna arrays 606 and 608. Although two antenna arrays 606 and 608 are illustrated in FIG. 6, it should be understood that the UE 600 may include any number of antenna arrays.

The UE 600 shown in FIGS. 6A and 6B is a foldable device that includes two tiles/panels 602 and 604, referred to herein as tiles. Each tile 602 and 604 includes an antenna array 606 and 608 (e.g., a single-polarization antenna array, such as a 5×1 antenna array), respectively. The antenna arrays 606 and 608 are placed adjacent (e.g., on opposite sides of) a hinge 618 connecting the tiles 602 and 604. An RFIC bump 610 may be placed on one of the antenna arrays (e.g., antenna array 606) and an RF connector 612 may couple the antenna arrays 606 and 608 together to collectively form a dual-polarization antenna array (e.g., 5×2).

Thus, the antenna arrays 606 and 608 may operate independently as separate single-polarization antenna arrays or may operate together as a dual-polarization antenna array. Dual-polarization antenna arrays are capable of transmitting and receiving signals in two orthogonal polarizations (e.g., horizontal and vertical or slant 45 degrees and slant minus 45 degrees) simultaneously, whereas single-polarization antenna arrays are capable of transmitting and receiving signals in only one polarization at a time. Dual-polarization, therefore, enhances signal diversity and provides improved signal strength/rates, thereby allowing for doubling the capacity of the system without increasing the bandwidth or transmit power.

In an independent mode in which each antenna array 606 and 608 operates separately (single-polarization), each antenna array (e.g., antenna array 606) may be capable of emitting or receiving energy in the form of a plurality of beams (e.g., single-polarization beams), each in a different spatial direction. For example, the beams may include respective boresight directions of the antenna arrays 606 and 608 and a neighborhood of the boresight directions of the antenna arrays 606 and 608. An example of a neighborhood includes the regions that are within +/−M degrees in both elevation (θ) and azimuth (φ) from the boresight direction, where M is less than 180 degrees and is configured or chosen appropriately. Typically, at millimeter wave carrier frequencies, M is chosen to be 30 to 45 degrees since the antenna elements are directional by design and due to the nature of the carrier frequency.

The number of beams generated/received per antenna array 606 and 608 may depend, for example, on the number of antenna subarrays and the number of antenna elements in each subarray of each antenna array 606 and 608. In general, to meet link budget requirements for downlink transmissions (e.g., from the gNB to the UE 600), each antenna array 606 and 608 may support N beams per N antenna element subarrays in the module. Such a design ensures that the cross-over point between adjacently steered beams is approximately 4 dB below the peak of the main lobe. For example, assuming that there is one antenna subarray per antenna array 606 and 608, the UE 600 may support N beams per antenna array and 2N beams in total. However, it should be understood that each antenna array 606 and 608 may support any suitable numbers of beams and this is a design parameter/metric capturing the performance-latency tradeoffs.

In a combined mode in which the antenna arrays 606 and 608 combine to form a dual-polarization antenna array, the combined antenna array 606/608 may be capable of emitting or receiving energy in the form of a plurality of different beams (e.g., dual-polarization beams), each in a different spatial direction. The different beams may include a boresight direction of the combined antenna array 606/608 and a neighborhood of the boresight direction of the combined antenna array 606/608, as described above.

Whether operating in the independent mode or the combined mode, the beamformed signals are produced by selection of appropriate beam weights for each of the antenna elements in one or both of the antenna arrays 606/608. The beam weights determine the phases of each of the antenna elements such that the signals received at each of the antenna elements coherently combine to maximize the signal strength along a certain direction (e.g., a beam). For example, a beamformed signal w_{RF} may be represented as:

$${w}_{RF} = [ {ω}_{1} , {ω}_{2} … {ω}_{10} ] with \vert {ω}_{i} \vert \leq ω ,$$

where ωᵢ is the phase of the corresponding antenna element.

In some examples, beamforming can be performed with static/non-adaptive directional beams (static beam weights) that are pre-configured and stored as beamforming codebooks within the RFIC chip memory. For example, the UE 600 may include a beamforming codebook for operation in the independent mode and an additional beamforming codebook for operation in the combined mode. Each beamforming codebook may be associated, for example, with a different foldable state of the UE 600.

For example, in a fully-closed foldable state 614, as shown in FIG. 6A, the UE 600 may operate in the independent mode (e.g., with single/uni-polarization). In this example, the antenna arrays 606 and 608 are placed on opposite sides 622 and 624 of the folded UE 600 with the RFIC chip bump 610 on one of the two sides (e.g., on antenna array 606) and the RF connector 612 connecting the RFIC chip bump 610 to the other antenna array 608 to share the signal between the antenna arrays 606 and 608. Although there may be a feedline loss resulting from sharing the signal from one side/tile to the other side/tile, the loss should be small as the thickness of the UE is small in foldable designs (e.g., 2-4 mm edge thickness).

In a fully-open foldable state 616, as shown in FIG. 6B, the UE 600 may operate in the combined mode (e.g., with dual-polarization). In this example, the hinge 618 retracts the RF connector 612 and the two antenna arrays 606 and 608 on the two tiles 602 and 604 effectively form a single larger antenna array 620 (e.g., a 5×2 antenna array instead of two 5×1 antenna arrays). There are multiple different foldable states between the fully-closed state 614 shown in FIG. 6A and the fully-open state 616 shown in FIG. 6B, each producing a different antenna array configuration of the antenna arrays 606 and 608. For example, the more foldable states that are possible on the UE 600, the greater the number of possible antenna array configurations at the UE 600.

In general, in foldable devices (or devices where the form factor changes dynamically), multiple antenna array configurations are possible, and each antenna array configuration (e.g., corresponding to a foldable state) may need a separate beamforming codebook matched to the antenna array configuration. However, as the RFIC chip memory is limited, analog/hybrid beamforming codebooks for every realizable possible antenna array configuration may not be able to be stored in the RFIC chip memory. Even with a matched beamforming codebook, good performance in practice relies on calibration to be performed. Without a codebook matched to and calibration for the realized antenna array configuration, performance loss may be significant.

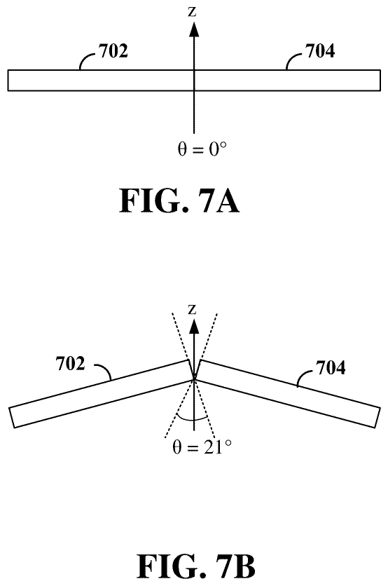

FIGS. 7A and 7B are diagrams illustrating other examples of foldable states of a UE according to some aspects. In the examples shown in FIGS. 7A and 7B, the UE includes two tiles 702 and 704. As shown in FIG. 7A, the tiles 702 and 704 may be parallel to each other in a “fully-open” foldable state. In this foldable state, an angular separation between the two tiles 702 and 704 (e.g., through the z-axis) is zero (0) degrees (θ=0°). However, as shown in FIG. 7B, the tiles 702 and 704 may be tilted with respect to one another about the z-axis, resulting in a foldable state of the UE in which the angular separation between the two tiles 702 and 704 is twenty-one degrees (θ=21°). If the beamforming codebook used by the UE is designed for an “ideal” placement of the tiles 702 and 704, as shown in the example of FIG. 7A (e.g., θ=0°), there may be a significant performance loss in the “non-ideal” placement of the tiles 702 and 704, as shown in the example of FIG. 7B. For example, 3 dB peak or even higher performance losses may be observed with a mismatched beamforming codebook.

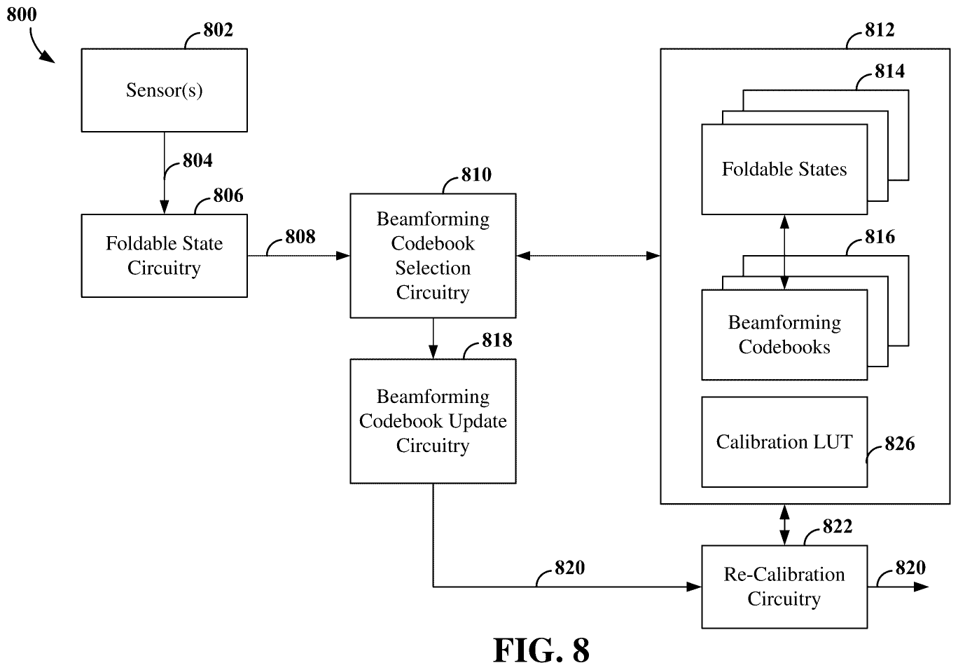

FIG. 8 is a diagram illustrating an example of a UE 800 configured to update a beamforming codebook based on the foldable state of the UE according to some aspects. The UE 800 includes one or more sensors 802, each configured to generate a set of sensor data 804 related to a current foldable state 808 of the UE 800. For example, the sensor(s) 802 may include one or more of a position sensor, rotational sensor, camera, gyroscope, capacitive sensor, or other suitable sensor.

The UE 800 further includes foldable state circuitry 806, configured to identify the current foldable state 808 of the UE 800 based on the sensor data 804. The current foldable state 808 may be defined by an angular separation between tiles/panels of the UE 800, which may be determined based on the sensor data 804. For example, the UE 800 may include a first tile including a first antenna array and a second tile including a second antenna array. The first tile and the second tile may be coupled via a hinge that rotates the first tile and the second tile between a fully-open foldable state in which the first tile and the second tile are parallel and fully non-overlapping, and a fully-closed foldable state in which the first tile and the second tile are fully overlapping. In addition, the first and second antenna arrays may be operated in independent modes or in a combined mode, depending on the foldable state. The foldable state circuitry 806 may be configured to calculate a current angular separation between the first tile and the second tile based on the set of sensor data and identify the current foldable state 808 (e.g., in the range between and including the fully-open foldable state and the fully-closed foldable state) based on the current angular separation.

The UE 800 further includes beamforming codebook selection circuitry 810, configured to receive the current foldable state 808 and to access a memory 812 (e.g., an RFIC chip memory) storing a plurality of configured foldable states 814 (e.g., pre-configured foldable states) and associated beamforming codebooks 816. For example, the memory 812 may store a plurality of beamforming codebooks 816, each corresponding to an N×K matrix of beam weights, where N is the number of antennas (e.g., across the first and second antenna arrays) and K is the number of beams. Each of the beamforming codebooks 816 may to a correspond particular configured (pre-configured/predetermined) foldable state 814 of the UE 800. For example, the memory 812 may include a lookup table including a plurality of configured foldable states 814 and an identity of the corresponding beamforming codebook 816 for each of the foldable states 814.

The beamforming codebook selection circuitry 810 may be configured to access the memory 812 to select a beamforming codebook of the plurality of beamforming codebooks 816 that is the best fit for the current foldable state 808. For example, the selected beamforming codebook 816 may be associated with a configured foldable state 814 that is nearest to or closest to the angular separation associated with the current foldable state 808 from among all of the beamforming codebooks 816 and associated configured foldable states 814. In an example, the beamforming codebook selection circuitry 810 may be configured to compare the current foldable state 808 with each of the configured foldable states 814. If there is a match (e.g., the current foldable state 808 matches one of the configured foldable states 814), the beamforming codebook selection circuitry 810 selects the beamforming codebook 816 associated with the current foldable state 808. If not, the beamforming codebook selection circuitry 810 identifies the closest foldable state 814 (e.g., having the nearest angular separation) to the current foldable state 808 and selects the beamforming codebook 816 associated with the closest foldable state 814.

The UE 800 further includes beamforming codebook update circuitry 818, configured to receive the selected beamforming codebook 816 from the beamforming codebook selection circuitry 810 and to update the selected beamforming codebook 816, if necessary, to produce an updated beamforming codebook 820. In examples in which the configured foldable state 814 associated with the selected beamforming codebook 816 matches the current foldable state 808, the beamforming codebook update circuitry 818 may be configured to directly output the selected beamforming codebook 816 as the updated beamforming codebook 820.

In examples in which the configured foldable state 814 associated with the selected beamforming codebook 816 does not match the current foldable state 808, the beamforming codebook update circuitry 818 may be configured to analyze a current performance of the selected beamforming codebook 816 for the current foldable state and compare the current performance with an expected performance of the UE. The expected/current performance may be based, for example, on a theoretical array gain based on the number of antenna elements in the antenna arrays when the beams from each antenna array are steered towards a boresight direction. In an example, the signal strength (e.g., SINR or RSRP) or effective/equivalent isotropic radiated power (EIRP) associated with the beams in the selected beamforming codebook may be measured using one or more downlink reference signals. Those measurements may be compared with the gain expected over the number of antenna elements (N) at the receiver. For example, the signal strength or EIRP may be compared against 10*log 10 (N), where N is the number of antenna elements across the antenna arrays over the two tiles/panels. If the measured signal strength/EIRP is significantly lower (e.g., more than a threshold lower) than the benchmark comparison, a codebook update may be performed. In some examples, the selected beamforming codebook 816 may include a first set of beam weights associated with a respective predetermined set of beam directions (e.g., boresight directions or other directions) from each of the antenna arrays and the beamforming codebook update circuitry 818 may be configured to analyze the selected beamforming codebook 816 for the current foldable state 808 using the first set of beam weights.

If the current performance of the selected beamforming codebook 816 for the current foldable state 808 meets the expected performance (that is, if the actual measured signal strength performance is comparable with a theoretical array gain expectation), the beamforming codebook update circuitry 818 may output the selected beamforming codebook 816 as the updated beamforming codebook 820. In this example, no updates are made to the selected beamforming codebook 816 and the UE may use the selected beamforming codebook 816 for beamforming in the current foldable state 808.

However, if the current performance of the selected beamforming codebook 816 for the current foldable state fails to meet the expected performance, the beamforming codebook update circuitry 818 may be configured to update the selected beamforming codebook 816 to produce the updated beamforming codebook 820. For example, the beamforming codebook update circuitry 818 may be configured to determine a set of one or more co-phasing factors, each indicating a respective phase deviation across the antenna arrays based on the current foldable state 808 and to modify one or more beam weights in the selected beamforming codebook 816 using the set of co-phasing factors to produce the updated beamforming codebook 820.

In some examples, the beamforming codebook update circuitry 818 may be configured to determine the co-phasing factors based on communication of downlink and/or uplink reference signals with a network entity. For example, the beamforming codebook update circuitry 818 may be configured to measure the signal strength (e.g., SINR or RSRP) of one or more downlink reference signals (e.g., SSBs, CSI-RSs, etc.) or the channel impulse response (e.g., amplitude and phase) based on the one or more downlink reference signals. Based on the measurements, the beamforming codebook update circuitry 818 may be configured to update the selected beamforming codebook 816 to produce the updated beamforming codebook 820. In examples in which the measurements are explicit (e.g., each beam in the beamforming codebook may be measured using, for example, signal strength measurements), the beamforming codebook update circuitry 818 may be configured to determine the co-phasing factors from the explicit measurements and then update the selected beamforming codebook 816 (e.g., modify the beam weights) using the co-phasing factors. In examples in which the measurements are implicit (e.g., channel impulse response), the beamforming codebook update circuitry 818 may be configured to determine the co-phasing factors from the implicit measurements and then update the selected beamforming codebook 816 (e.g., modify the beam weights) using the co-phasing factors.

In other examples, the beamforming codebook update circuitry 818 may be configured to transmit one or more uplink reference signals (e.g., SRSs, etc.) to the network entity and to receive feedback from the network entity based on the one or more uplink reference signals (e.g., based on measurements of the uplink reference signals performed by the network entity). In some examples, the feedback may include one or more co-phasing factors, each indicating a respective phase deviation across the antenna arrays based upon respective combinations of the one or more uplink reference signals. In other examples, the feedback may include one or more updated beam weights to be directly applied by the beamforming codebook update circuitry 818 to the selected beamforming codebook 816 to produce the updated beamforming codebook 820.

The UE 800 may further include re-calibration circuitry 822, configured to re-calibrate the updated beamforming codebook 820, if necessary for uplink-downlink radio frequency (RF) circuit level mismatches and update a calibration lookup table (LUT) 826 within, for example, memory 812. In examples in which the updated beamforming codebook 820 is the same as the selected beamforming codebook 816 (e.g., no updates were made), the re-calibration may not need to be performed. However, in examples in which the updated beamforming codebook 820 is different than the selected beamforming codebook 816, the re-calibration circuitry 822 may be configured to re-calibrate the updated beamforming codebook 820.

For example, there may be circuit mismatches (e.g., radio frequency circuit level mismatches) between the uplink and downlink that may be accommodated in the UE. In an example, if a beamforming codebook includes a particular beam weight (phase) for a certain downlink beam or a certain uplink beam, the calibration lookup table (LUT) 826 can indicate the corresponding beam weight (phase) to produce the same beam on the reverse link (e.g., uplink or downlink). However, the lookup table 826 may not be available in its entirety (e.g., for all phases of all beams), especially after performing an update to a beamforming codebook based on the current foldable state 808. Therefore, the re-calibration circuitry 822 may be configured to perform a re-calibration of the updated beamforming codebook 820 to account for the uplink-downlink RF circuit level mismatches in the UE. In some examples, the re-calibration circuitry 822 may be configured to re-calibrate the updated beamforming codebook 820 based on communication of additional downlink and/or uplink reference signals with the network entity. The reference signals utilized for calibration may be different than the reference signals utilized for codebook update. Based on various measurements of downlink and/or uplink reference signals, the re-calibration circuitry 822 may be configured to make the calibration adjustments to the lookup table 826.

In an example, if the updated beamforming codebook 820 is produced based on measurements of downlink reference signals, and therefore, the updated beamforming codebook 820 indicates the beam weights to be applied to downlink beams, the re-calibration circuitry 822 may be configured to re-calibrate the updated beamforming codebook 820 to indicate the corresponding beam weights to be applied to the same beams on the uplink. In another example, if the updated beamforming codebook 820 is produced based on measurements of uplink reference signals, and therefore, the updated beamforming codebook 820 indicates the beam weights to be applied to uplink beams, the re-calibration circuitry 822 may be configured to re-calibrate the updated beamforming codebook 820 to indicate the corresponding beam weights to be applied to the same beams on the downlink.

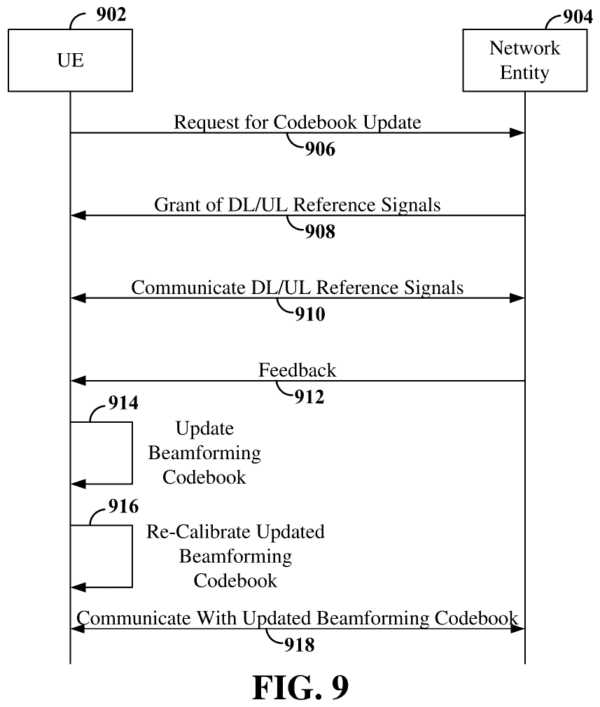

FIG. 9 is a signaling diagram illustrating exemplary signaling between a UE 902 and a network entity 904 for updating a beamforming codebook based on a foldable state of UE according to some aspects. The UE 902 may correspond to any of the UEs or other wireless communication devices shown in any of FIGS. 1, 3-8C, 11 and/or 12. The network entity 904 may correspond to any of the base stations or other network entities shown in FIGS. 1, 3-6, and/or 8. For example, the network entity 904 may correspond to an aggregated base station, an RU, a DU, a CU, a TRP, an IAB node, or other network device.

At 906, the UE 902 may transmit a request for a codebook update to the network entity 904. For example, the UE 902 may determine that a codebook update is needed based on the current foldable state of the UE 902. In an example, the UE 902 may select a first beamforming codebook from a plurality of beamforming codebooks maintained by the UE based on the current foldable state and analyze a current performance of the first beamforming codebook for the current foldable state. The UE 902 may then transmit the request for the codebook update in response to the current performance of the first beamforming codebook failing to meet an expected performance for the current foldable state.

At 908, the UE 902 may receive a grant of one or more downlink reference signals (DL RSs) and/or one or more uplink reference signals (UL RSs) from the network entity. For example, the UE 902 may receive a grant of one or more DL RSs (e.g., SSBs, CSI-RSs, etc.) from the network entity to perform the codebook update. As another example, the UE 902 may receive a grant of one or more UL RSs (e.g., SRSs) from the network entity to perform the codebook update.

At 910, the UE 902 and network entity 904 may communicate one or more DL RSs and/or one or more UL RSs based on the grant. For example, the UE 902 may receive one or more DL RSs from the network entity and/or the UE may transmit one or more UL RSs to the network entity 904.

In examples in which the UE 902 transmits one or more UL RSs to the network entity 904, at 912, the network entity 904 may provide feedback to the UE 902 based on the one or more UL RSs. For example, the network entity 904 may measure the signal strength of the received UL RSs or the channel impulse response based on the received UL RSs and provide feedback to the UE 902 to perform the codebook update. In some examples, the feedback includes a set of one or more co-phasing factors, each indicating a respective phase deviation across the antenna arrays of the UE based upon respective combinations of the one or more UL RSs. In other examples, the feedback includes one or more updated beam weights to apply to the first beamforming codebook.

At 914, the UE 902 updates the first beamforming codebook based on the communication of the DL/UL RSs. In some examples, the UE 902 measures the signal strength of received DL RSs or the channel impulse response based on the DL RSs to identify a set of one or more co-phasing factors, each indicating a respective phase deviation across the antenna arrays of the UE based on the current foldable state. The UE 902 may then modify one or more beam weights in the first beamforming codebook using the set of co-phasing factors. In other examples in which the UE 902 receives the feedback from the network entity 904, the UE 902 may update the beamforming codebook using the feedback (e.g., using the set of co-phasing factors or the updated beam weights).

At 916, the UE 902 may optionally re-calibrate the updated beamforming codebook for uplink-downlink radio frequency circuit mismatches. For example, the UE 902 may re-calibrate the updated beamforming codebook based on communication of one or more additional DL RSs and/or UL RSs. At 918, the UE 902 and network entity 904 may communicate with the updated beamforming codebook. For example, the UE 902 and network entity 904 may communication downlink and/or uplink control information and/or data using the updated beamforming codebook for the current foldable state.

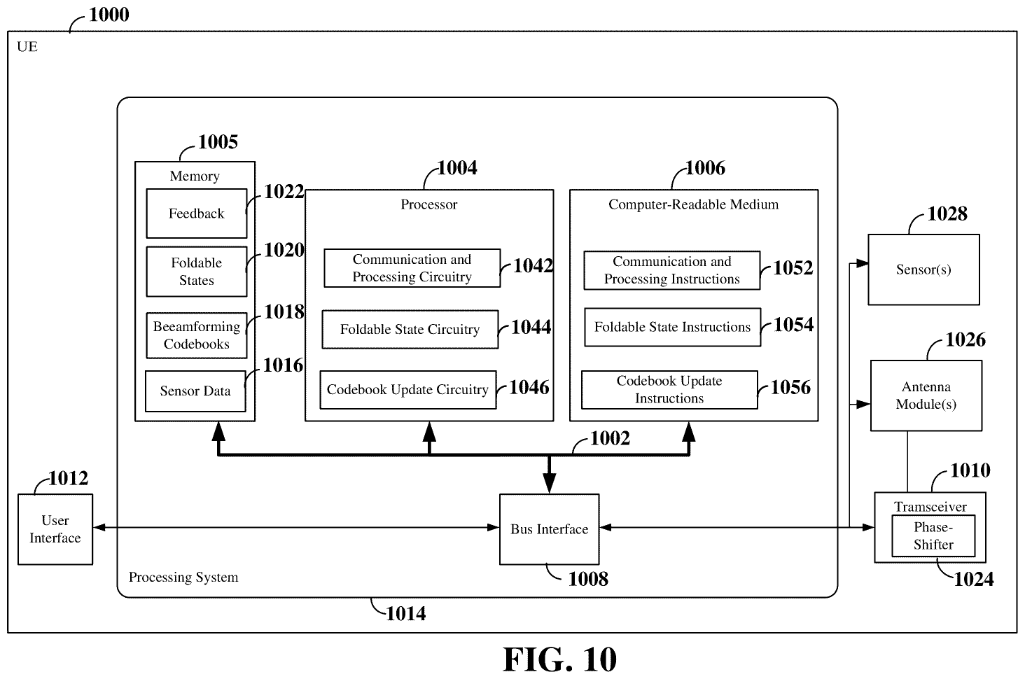

FIG. 10 is a block diagram illustrating an example of a hardware implementation of a user equipment (UE) 1000 employing a processing system 1014 according to some aspects. For example, the UE 1000 may correspond to any of the UEs shown and described above in reference to FIGS. 1, 3, 4, 6, 7, and/or 12.

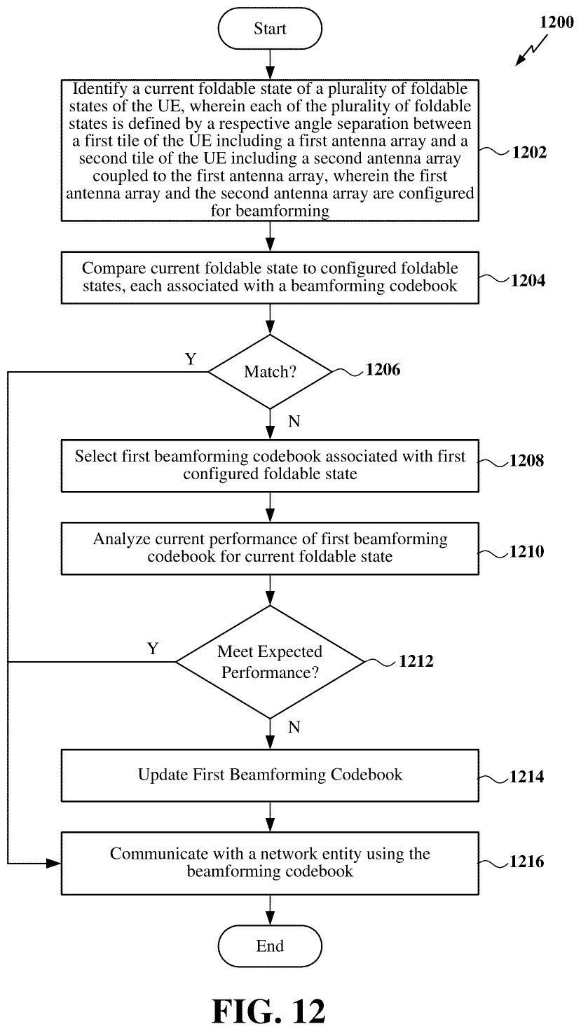

In accordance with various aspects of the disclosure, an element, or any portion of an element, or any combination of elements may be implemented with a processing system 1014 that includes one or more processors, such as processor 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1000 may be configured to perform any one or more of the functions described herein. That is, the processor 1004, as utilized in the UE 1000, may be used to implement any one or more of the methods or processes described and illustrated, for example, in FIGS. 12 and/or 14.

The processor 1004 may in some instances be implemented via a baseband or modem chip and in other implementations, the processor 1004 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits, including one or more processors (represented generally by the processor 1004), one or more memories (represented generally by the memory 1005), and one or more computer-readable media (represented generally by the computer-readable medium 1006). In some examples, the computer-readable media 1006 may be included within or part of one or more of the memories 1005. The bus 1002 may also link various other circuits such as timing sources, peripherals, voltage regulators, and power management circuits, which are well known in the art, and therefore, are not described any further.

A bus interface 1008 provides an interface between the bus 1002, one or more transceivers 1010, one or more antenna modules (e.g., one or more antenna arrays or panels) 1026, and one or more sensors 1028. The transceiver 1010 and antenna array(s) 1026 provides a means for communicating with various other apparatus over a transmission medium (e.g., air interface). The bus interface 1008 further provides an interface between the bus 1002 and a user interface 1012 (e.g., keypad, display, touch screen, speaker, microphone, control features, etc.). Of course, such a user interface 1012 may be omitted in some examples.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. In some examples, the computer-readable medium 1006 may be part of the memory 1005. Those skilled in the art will recognize how best to implement the described functionality presented throughout this disclosure depending on the particular application and the overall design constraints imposed on the overall system. In some examples, the computer-readable medium 1006 may be implemented on an article of manufacture, which may further include one or more other elements or circuits, such as the processor 1004 and/or memory 1005.

The computer-readable medium 1006 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1004, may be responsible for managing the bus 1002 and general processing, including the execution of the software (e.g., instructions or computer-executable code) stored on the computer-readable medium 1006. The software, when executed by the processor 1004, causes the processing system 1014 to perform the various processes and functions described herein for any particular apparatus. The computer-readable medium 1006 and/or the memory 1005 may also be used for storing data that may be manipulated by the processor 1004 when executing software. For example, the memory 1005 may store one or more of sensor data 1016, beamforming codebooks 1018, foldable states 1020 (e.g., configured foldable states, each associated with one of the plurality of beamforming codebooks 1018), and/or feedback 1022.

In some aspects of the disclosure, the processor 1004 may include circuitry configured for various functions. For example, the processor 1004 may include communication and processing circuitry 1042 configured to communicate with one or more UEs and/or one or more network entities. In some examples, the communication and processing circuitry 1042 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1042 may include one or more transmit/receive chains.

In some implementations where the communication involves receiving information, the communication and processing circuitry 1042 may obtain information from a component of the UE 1000 (e.g., from the transceiver 1010 that receives the information via radio frequency signaling or some other type of signaling suitable for the applicable communication medium), process (e.g., decode) the information, and output the processed information. For example, the communication and processing circuitry 1042 may output the information to another component of the processor 1004, to the memory 1005, or to the bus interface 1008. In some examples, the communication and processing circuitry 1042 may receive one or more of signals, messages, other information, or any combination thereof. In some examples, the communication and processing circuitry 1042 may receive information via one or more channels. In some examples, the communication and processing circuitry 1042 may include functionality for a means for receiving. In some examples, the communication and processing circuitry 1042 may include functionality for a means for processing, including a means for demodulating, a means for decoding, etc.

In some implementations where the communication involves sending (e.g., transmitting) information, the communication and processing circuitry 1042 may obtain information (e.g., from another component of the processor 1004, the memory 1005, or the bus interface 1008), process (e.g., modulate, encode, etc.) the information, and output the processed information. For example, the communication and processing circuitry 1042 may output the information to the transceiver 1010 (e.g., that transmits the information via radio frequency signaling or some other type of signaling suitable for the applicable communication medium). In some examples, the communication and processing circuitry 1042 may send one or more of signals, messages, other information, or any combination thereof. In some examples, the communication and processing circuitry 1042 may send information via one or more channels. In some examples, the communication and processing circuitry 1042 may include functionality for a means for sending (e.g., a means for transmitting). In some examples, the communication and processing circuitry 1042 may include functionality for a means for generating, including a means for modulating, a means for encoding, etc.

In some examples, the communication and processing circuitry 1042 may be configured to receive and process downlink beamformed signals at a mmWave frequency or a sub-6 GHz frequency via the transceiver 1010 and the antenna module(s) 1026 (e.g., using a phase-shifter 1024). In addition, the communication and processing circuitry 1042 may be configured to generate and transmit uplink beamformed signals at a mmWave frequency or a sub-6 GHz frequency via the transceiver 1010 and antenna module(s) 1026 (e.g., using the phase-shifter 1024).

In some examples, the communication and processing circuitry 1042 may be configured to communicate with a network entity (e.g., aggregated or disaggregated base station gNB, TRP(s), etc.) using a beamforming codebook 1018, which may be an updated beamforming codebook in accordance with aspects described herein. The updated beamforming codebook 1018 may further be re-calibrated, in accordance with aspects described herein, to enable the updated beamforming codebook 1018 to be utilized for both downlink communication and uplink communication.

In some examples, the communication and processing circuitry 1042 may be configured to transmit a request to the network entity for a codebook update. The communication and processing circuitry 1042 may further be configured to receive a grant of one or more downlink reference signals and/or one or more uplink reference signals for the codebook update. The communication and processing circuitry 1042 may further be configured to communicate the one or more downlink reference signals and/or the one or more uplink reference signals with the network entity based on the grant.

In some examples, the communication and processing circuitry 1042 may further be configured to receive feedback 1022 from the network entity in response to transmitting one or more uplink reference signals to the network entity. The feedback 1022 may include, for example, a set of one or more co-phasing factors, each indicating a respective phase deviation across the antenna arrays of the UE based upon respective combinations of the one or more UL RSs. In other examples, the feedback 1022 includes one or more updated beam weights to apply to the first beamforming codebook. The feedback 1022 may be stored, for example, in the memory 1005. The communication and processing circuitry 1042 may further be configured to execute communication and processing software 1052 stored on the computer-readable medium 1006 to implement one or more functions described herein.

The processor 1004 may further include foldable state circuitry 1044, configured to identify or determine a current foldable state of the UE 1000. In some examples, the foldable state circuitry 1044 corresponds to or includes the foldable state circuitry 806 shown in FIG. 8. For example, the foldable state circuitry 1044 may be configured to calculate a current angular separation between a first tile (or panel) of the UE 1000 and a second tile (or panel) of the UE 1000 based on a set of sensor data 1016 generated by the one or more sensors 1028. The sensor(s) 1028 may include one or more of a position sensor, rotational sensor, camera, gyroscope, capacitive sensor, or other suitable sensor. The foldable state circuitry 1044 may further be configured to identify the current foldable state based on the current angular separation.

The first tile of the UE 1000 may include a first antenna array 1026 and the second tile of the UE may include a second antenna array 1026, in which the first and second antenna arrays are configured for beamforming. In some examples, the first tile and the second tile may be foldable via a hinge connecting the first tile and the second tile. For example, the hinge may be configured to fold the tiles into a plurality of foldable states between and including a “fully-open” foldable state in which the tiles are parallel and completely non-overlapping and a “fully-closed” foldable state in which the tiles are completely overlapping (the tiles are on top of one another). Each of the foldable states of the UE 1000 may be defined by a respective angular separation between the first and second tiles. Select ones of the foldable states may be predetermined or pre-configured and stored within the memory 1005 as configured foldable states 1020. Each of the configured foldable states 1020 may be associated with a respective pre-stored beamforming codebook 1018 such that each of the plurality of beamforming codebooks 1018 stored in the memory is designed for a particular configured foldable state 1020. The foldable state circuitry 1044 may further be configured to execute foldable state instructions (software) 1054 stored on the computer-readable medium 1006 to implement one or more functions described herein.

The processor 1004 may further include codebook update circuitry 1046, configured to update a beamforming codebook 1018 (e.g., one of the pre-stored beamforming codebooks 1018) based on the current foldable state of the UE 1000 to produce an updated beamforming codebook. In some examples, the codebook update circuitry 1046 may correspond to or include one or more of the beamforming codebook selection circuitry 810, beamforming codebook update circuitry 818, and/or the re-calibration circuitry 822 shown in FIG. 8. In some examples, the codebook update circuitry 1046 may be configured to compare the current foldable state to each of the respective configured foldable states 1020 associated with the plurality of beamforming codebooks 1018. The codebook update circuitry 1046 may further be configured to update the beamforming codebook 1018 in response to the current foldable state being different than any of the configured foldable states 1020.

In some examples, the codebook update circuitry 1046 may be configured to select a first beamforming codebook 1018 of the plurality of beamforming codebooks 1018, in which the first beamforming codebook is associated with a first configured foldable state 1020. The codebook update circuitry 1046 may further be configured to analyze a current performance of the first beamforming codebook for the current foldable state and update the first beamforming codebook to produce the updated beamforming codebook for the current foldable state in response to the current performance failing to meet an expected performance. In some examples, the angular separation associated with the first configured foldable state 1020 is nearest to the angular separation associated with the current foldable state among each of the plurality of beamforming codebooks 1018. In some examples, the first beamforming codebook includes a first set of beam weights associated with a respective predetermined set of beam directions from each of the first antenna array and the second antenna array. In this example, the codebook update circuitry 1046 may be configured to analyze the current performance utilizing the first set of beam weights. In some examples, the codebook update circuitry 1046 may be configured to determine a set of one or more co-phasing factors, each indicating a respective phase deviation across the first antenna array and the second antenna array based on the current foldable state and to modify one or more beam weights in the first beamforming codebook using the set of co-phasing factors to produce the updated beamforming codebook.

In some examples, the codebook update circuitry 1046 may be configured to update the beamforming codebook 1018 based on communication of at least one of one or more downlink reference signals or the one or more uplink reference signals granted by the network entity to perform the codebook update. In some examples, the codebook update circuitry 1046 may be configured to update the beamforming codebook 1018 using the feedback provided by the network entity to produce the updated beamforming codebook.

In some examples, the codebook update circuitry 1046 may be configured to re-calibrate the updated beamforming codebook for uplink-downlink radio frequency circuit level mismatches. The codebook update circuitry 1046 may further be configured to execute codebook update instructions (software) 1056 stored on the computer-readable medium 1006 to implement one or more functions described herein.

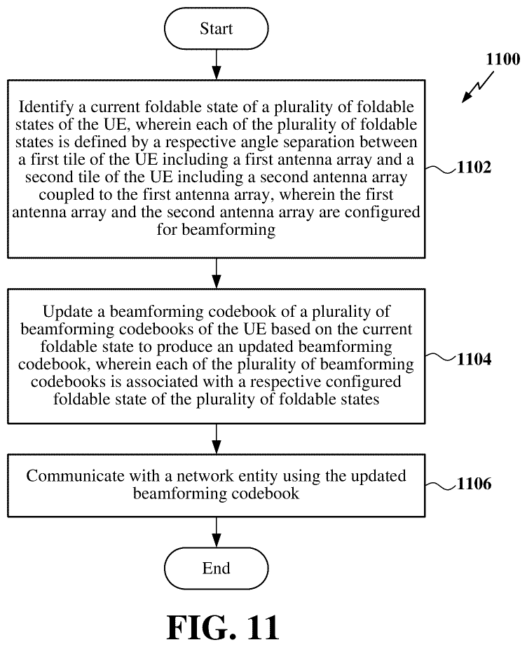

FIG. 11 is a flow chart illustrating an exemplary process 1100 for a UE to update a beamforming codebook based on a foldable state of the UE according to some aspects. As described below, some or all illustrated features may be omitted in a particular implementation within the scope of the present disclosure, and some illustrated features may not be required for implementation of all embodiments. In some examples, the process 1100 may be carried out by the UE 1000 illustrated in FIG. 10. In some examples, the process 1100 may be carried out by any suitable apparatus or means for carrying out the functions or algorithm described below.

At block 1102, the UE may identify a current foldable state of a plurality of foldable states of the UE, wherein each of the plurality of foldable states is defined by a respective angle separation between a first tile of the UE including a first antenna array and a second tile of the UE including a second antenna array coupled to the first antenna array, wherein the first antenna array and the second antenna array are configured for beamforming. In some examples, the UE may calculate a current angular separation between the first tile and the second tile based on a set of sensor data and identify the current foldable state based on the current angular separation. For example, the foldable state circuitry 1044, shown and described above in connection with FIG. 10, may provide a means to identify the current foldable state.

At block 1104, the UE may update a beamforming codebook of a plurality of beamforming codebooks of the UE based on the current foldable state to produce an updated beamforming codebook, wherein each of the plurality of beamforming codebooks is associated with a respective configured foldable state of the plurality of foldable states. In some examples, the UE may compare the current foldable state to each of the respective configured foldable states associated with the plurality of beamforming codebooks and update the beamforming codebook in response to the current foldable state being different than any of the configured foldable states. For example, the codebook update circuitry 1046, shown and described above in connection with FIG. 10, may provide a means to update the beamforming codebook.

In some examples, the UE may transmit a request for a codebook update to a network entity (e.g., as shown in FIG. 9). In this example, the UE may further receive a grant of at least one of one or more downlink reference signals or one or more uplink reference signals from the network entity and update the beamforming codebook based on communication of the at least one of the one or more downlink reference signals or the one or more uplink reference signals. In some examples, the UE may further re-calibrate the updated beamforming codebook for uplink-downlink radio frequency circuit level mismatches. In some examples, the UE may transmit the one or more uplink reference signals to the network entity and receive feedback from the network entity based on the one or more uplink reference signals. The UE may then update the beamforming codebook using the feedback to produce the updated beamforming codebook. In some examples, the feedback includes one or more co-phasing factors, each indicating a respective phase deviation across the first antenna array and the second antenna array based upon respective combinations of the one or more uplink reference signals. In some examples, the feedback includes one or more updated beam weights to produce the updated beamforming codebook.

At block 1106, the UE may communicate with a network entity using the updated beamforming codebook. For example, the communication and processing circuitry 1042, together with the transceiver 1010 and antenna module(s) 1026, shown and described above in connection with FIG. 10, may provide a means to communicate with the network entity using the updated beamforming codebook.

FIG. 12 is a flow chart illustrating another exemplary process 1100 for a UE to update a beamforming codebook based on a foldable state of the UE according to some aspects. As described below, some or all illustrated features may be omitted in a particular implementation within the scope of the present disclosure, and some illustrated features may not be required for implementation of all embodiments. In some examples, the process 1100 may be carried out by the UE 1000 illustrated in FIG. 10. In some examples, the process 1100 may be carried out by any suitable apparatus or means for carrying out the functions or algorithm described below.

At block 1202, the UE may identify a current foldable state of a plurality of foldable states of the UE, wherein each of the plurality of foldable states is defined by a respective angle separation between a first tile of the UE including a first antenna array and a second tile of the UE including a second antenna array coupled to the first antenna array, wherein the first antenna array and the second antenna array are configured for beamforming. In some examples, the UE may calculate a current angular separation between the first tile and the second tile based on a set of sensor data and identify the current foldable state based on the current angular separation. For example, the foldable state circuitry 1044, shown and described above in connection with FIG. 10, may provide a means to identify the current foldable state.

At block 1204, the UE may compare the current foldable state to each of the respective configured foldable states associated with the plurality of beamforming codebooks. At block 1206, the UE may determine whether there is a match between the current foldable state and one of the configured foldable states. For example, the codebook update circuitry 1046, shown and described above in connection with FIG. 10 may provide a means to compare the current foldable states to configured foldable states to determine if there is a match.

If there is a match (Y branch of block 1206), at block 1216, the UE may communicate with a network entity using the beamforming codebook associated with the configured foldable state that matches the current foldable state. For example, the communication and processing circuitry 1042, together with the transceiver 1010 and antenna module(s) 1026, shown and described above in connection with FIG. 10, may provide a means to communicate with the network entity using the beamforming codebook.

If there is not a match (N branch of block 1206), at block 1208, the UE may select a first beamforming codebook of the plurality of beamforming codebooks associated with a first configured foldable state. In some examples, the angular separation associated with the first configured foldable state is nearest to the angular separation associated with the current foldable state among each of the plurality of beamforming codebooks. For example, the codebook update circuitry 1046, shown and described above in connection with FIG. 10, may provide a means to select the first beamforming codebook.

At block 1210, the UE may analyze a current performance of the first beamforming codebook with the current foldable state. In some examples, the first beamforming codebook includes a first set of beam weights associated with a respective predetermined set of beam directions from each of the first antenna array and the second antenna array and the UE may analyze the current performance utilizing the first set of beam weights. At block 1212, the UE may determine whether the current performance meets an expected performance for the UE. For example, the codebook update circuitry 1046, shown and described above in connection with FIG. 10, may provide a means to analyze the current performance of the first beamforming codebook to determine whether the current performance meets the expected performance.

If the current performance meets the expected performance (Y branch of block 1212), at block 1216, the UE may communicate with a network entity using the first beamforming codebook. For example, the communication and processing circuitry 1042, together with the transceiver 1010 and antenna module(s) 1026, shown and described above in connection with FIG. 10, may provide a means to communicate with the network entity using the first beamforming codebook.

If the current performance fails to meet the expected performance (N branch of block 1212), at block 1214, the UE may update the first beamforming codebook to produce an updated beamforming codebook for the current foldable state. In some examples, the UE may determine a set of one or more co-phasing factors, each indicating a respective phase deviation across the first antenna array and the second antenna array based on the current foldable state, and modify one or more beam weights in the first beamforming codebook using the set of co-phasing factors to produce the updated beamforming codebook. For example, the codebook update circuitry 1046, shown and described above in connection with FIG. 10, may provide a means to update the first beamforming codebook to produce the updated beamforming codebook.

At block 1216, the UE may communicate with a network entity using the updated beamforming codebook. For example, the communication and processing circuitry 1042, together with the transceiver 1010 and antenna module(s) 1026, shown and described above in connection with FIG. 10, may provide a means to communicate with the network entity using the updated beamforming codebook.

In one configuration, the UE includes means for identifying a current foldable state of a plurality of foldable states of the UE, wherein each of the plurality of foldable states is defined by a respective angular separation between a first tile of the UE and a second tile of the UE, wherein the first tile comprises a first antenna array and the second tile comprises a second antenna array coupled to the first antenna array, wherein the first antenna array and the second antenna array are configured for beamforming, means for updating a beamforming codebook of a plurality of beamforming codebooks of the UE based on the current foldable state to produce an updated beamforming codebook, wherein each of the plurality of beamforming codebooks is associated with a respective configured foldable state of the plurality of foldable states, and means for communicating with a network entity using the updated beamforming codebook. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 3-8, and/or 10, and utilizing, for example, the processes and/or algorithms described herein in relation to FIGS. 9, 11, and 12.

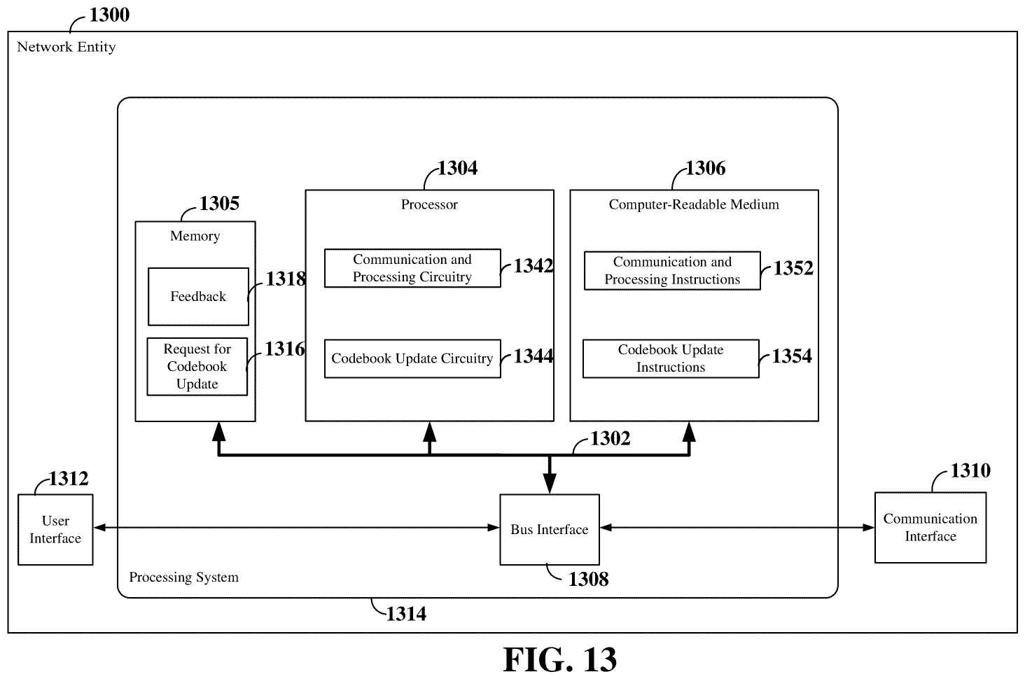

FIG. 13 is a block diagram illustrating an example of a hardware implementation of a network entity 1300 employing a processing system 1314 according to some aspects. The network entity 1300 may be, for example, a network entity or other network node illustrated in any one or more of FIGS. 1, 3, 4, and/or 9. For example, the network entity may be a base station (e.g., gNB, eNB) or other scheduling entity as illustrated in any one or more of FIGS. 1 and/or 3. A network entity may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, a network entity may be a stationary network entity or a mobile network entity.

In accordance with various aspects of the disclosure, an element, or any portion of an element, or any combination of elements may be implemented with a processing system 1314 that includes one or more processors, such as processor 1304. The processing system 1314 may be substantially the same as the processing system 1614 as shown and described above in connection with FIG. 16, including a bus interface 1308, a bus 1302, a memory 1305 (e.g., one or more memories), a processor 1304 (e.g., one or more processors), and a computer-readable medium 1306 (e.g., one or more computer-readable mediums). Accordingly, their descriptions will not be repeated for the sake of brevity. Furthermore, the network entity 1300 may include an optional user interface 1312 and a communication interface 1310 (e.g., wired or wireless), such as one or more transceivers or one or more network interfaces.

The processor 1304, as utilized in the network entity 1300, may be used to implement any one or more of the processes described below. In some examples, the memory 1305 may store a request 1316 for a codebook update and/or feedback 1318.

In some aspects of the disclosure, the processor 1304 may include communication and processing circuitry 1342 configured for various functions, including, for example, communicating with one or more wireless communication devices (e.g., UEs), a core network node, or other network entity. In some examples (e.g., in an aggregated base station architecture), the communication and processing circuitry 1342 may include one or more hardware components that provide the physical structure that performs processes related to wireless communication (e.g., signal reception and/or signal transmission) and/or signal processing (e.g., processing a received signal and/or processing a signal for transmission). In addition, the communication and processing circuitry 1342 may be configured to process and transmit downlink traffic and downlink control and receive and process uplink traffic and uplink control.

In some examples, the communication and processing circuitry 1342 may be configured to receive a request 1316 for a beamforming codebook update from a UE based on a current foldable state of a plurality of foldable states of the UE, wherein each of the plurality of foldable states is defined by a respective angle separation between a first tile of the UE including a first antenna array and a second tile of the UE including a second antenna array coupled to the first antenna array. The communication and processing circuitry 1342 may further store the request 1316 within, for example, memory 1305.

The communication and processing circuitry 1342 may further be configured to grant one or more downlink and/or uplink reference signals to the UE to update a beamforming codebook of the UE. The communication and processing circuitry 1342 may further be configured to provide feedback 1318 to the UE based on one or more uplink reference signals to update the beamforming codebook. The communication and processing circuitry 1342 may further be configured to communicate with the UE using the updated beamforming codebook. The communication and processing circuitry 1342 may further be configured to execute communication and processing software 1352 stored on the computer-readable medium 1306 to implement one or more functions described herein.

The processor 1304 may further include codebook update circuitry 1344, configured to generate the grant of the one or more downlink reference signals and/or one or more uplink reference signals for the beamforming codebook update. The codebook update circuitry 1344 may further be configured to process the one or more uplink reference signals to produce the feedback 1318. In some examples, the feedback includes one or more co-phasing factors, each indicating a respective phase deviation across the first antenna array and the second antenna array based upon respective combinations of the one or more uplink reference signals. In other examples, the feedback includes one or more updated beam weights to enable the UE to produce the updated beamforming codebook. In some examples, the codebook update circuitry 1344 may update the beamforming codebook for the UE based on the feedback 1318 and store the updated beamforming codebook (not shown) within, for example, memory 1305. The codebook update circuitry 1344 may further be configured to execute codebook update software 1354 stored on the computer-readable medium 1306 to implement one or more functions described herein.

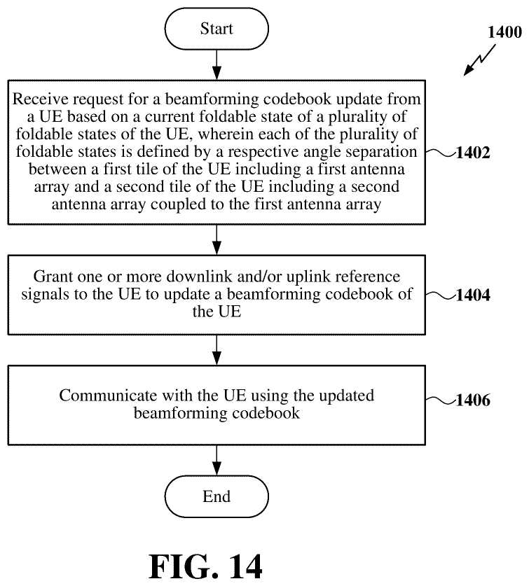

FIG. 14 is a flow chart illustrating an exemplary process 1400 for a network entity to facilitate updating a beamforming codebook of a UE based on a foldable state of the UE according to some aspects. As described below, some or all illustrated features may be omitted in a particular implementation within the scope of the present disclosure, and some illustrated features may not be required for implementation of all embodiments. In some examples, the process 1400 may be carried out by the network entity 1300 illustrated in FIG. 13. In some examples, the process 1400 may be carried out by any suitable apparatus or means for carrying out the functions or algorithm described below.

At block 1402, the network entity may receive a request for a beamforming codebook update from a UE based on a current foldable state of a plurality of foldable states of the UE, wherein each of the plurality of foldable states is defined by a respective angle separation between a first tile of the UE including a first antenna array and a second tile of the UE including a second antenna array coupled to the first antenna array. For example, the communication and processing circuitry 1342, together with the communication interface 1310, shown and described above in connection with FIG. 13 may provide a means to receive the request.

At block 1404, the network entity may grant one or more downlink and/or uplink reference signals to the UE to update a beamforming codebook of the UE. For example, the communication and processing circuitry 1342, together with the codebook update circuitry 1344 and communication interface 1310, shown and described above in connection with FIG. 13 may provide a means to grant the uplink and/or downlink reference signals to the UE.

At block 1406, the network entity may communicate with the UE using the updated beamforming codebook. For example, the communication and processing circuitry 1342, together with the communication interface 1310, shown and described above in connection with FIG. 13 may provide a means to communicate with the UE using the updated beamforming codebook.

In one configuration, the UE includes means for receiving a request for a beamforming codebook update from a UE based on a current foldable state of a plurality of foldable states of the UE, wherein each of the plurality of foldable states is defined by a respective angle separation between a first tile of the UE including a first antenna array and a second tile of the UE including a second antenna array coupled to the first antenna array, means for granting one or more downlink and/or uplink reference signals to the UE to update a beamforming codebook of the UE, and means for communicating with the UE using the updated beamforming codebook. In one aspect, the aforementioned means may be the processor 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 1, 3, and/or 13, and utilizing, for example, the processes and/or algorithms described herein in relation to FIGS. 9 and 14.

The following provides an overview of aspects of the present disclosure:

Aspect 1: A method operable at a user equipment (UE), the method comprising: identifying a current foldable state of a plurality of foldable states of the UE, wherein each of the plurality of foldable states is defined by a respective angular separation between a first tile of the UE and a second tile of the UE, wherein the first tile comprises a first antenna array and the second tile comprises a second antenna array coupled to the first antenna array, wherein the first antenna array and the second antenna array are configured for beamforming; updating a beamforming codebook of a plurality of beamforming codebooks of the UE based on the current foldable state to produce an updated beamforming codebook, wherein each of the plurality of beamforming codebooks is associated with a respective configured foldable state of the plurality of foldable states; and communicating with a network entity using the updated beamforming codebook.

Aspect 2: The method of aspect 1, wherein the updating the beamforming codebook further comprises: comparing the current foldable state to each of the respective configured foldable states associated with the plurality of beamforming codebooks; and updating the beamforming codebook in response to the current foldable state being different than any of the configured foldable states.

Aspect 3: The method of aspect 1 or 2, wherein the updating the beamforming codebook further comprises: selecting a first beamforming codebook of the plurality of beamforming codebooks, wherein the first beamforming codebook is associated with a first configured foldable state; analyzing a current performance of the first beamforming codebook for the current foldable state; and updating the first beamforming codebook to produce the updated beamforming codebook for the current foldable state in response to the current performance failing to meet an expected performance.

Aspect 4: The method of aspect 3, wherein the angular separation associated with the first configured foldable state is nearest to the angular separation associated with the current foldable state among each of the plurality of beamforming codebooks.

Aspect 5: The method of aspect 3 or 4, wherein the first beamforming codebook comprises a first set of beam weights associated with a respective predetermined set of beam directions from each of the first antenna array and the second antenna array and wherein the analyzing the current performance further comprises: analyzing the current performance utilizing the first set of beam weights.

Aspect 6: The method of any of aspects 3 through 5, wherein the updating the first beamforming codebook further comprises: determining a set of one or more co-phasing factors, each indicating a respective phase deviation across the first antenna array and the second antenna array based on the current foldable state; and modifying one or more beam weights in the first beamforming codebook using the set of one or more co-phasing factors to produce the updated beamforming codebook.

Aspect 7: The method of any of aspects 1 through 6, further comprising: transmitting a request for a codebook update to the network entity.

Aspect 8: The method of aspect 7, wherein the updating the beamforming codebook further comprising: receiving a grant of at least one of one or more downlink reference signals or one or more uplink reference signals from the network entity; communicating the at least one of the one or more downlink reference signals or the one or more uplink reference signals with the network entity; and updating the beamforming codebook based on communication of the at least one of the one or more downlink reference signals or the one or more uplink reference signals.

Aspect 9: The method of aspect 8, further comprising: re-calibrating the updated beamforming codebook for uplink-downlink radio frequency circuit level mismatches.

Aspect 10: The method of aspect 8 or 9, wherein the updating the beamforming codebook further comprising: transmitting the one or more uplink reference signals to the network entity; receiving feedback from the network entity based on the one or more uplink reference signals; and updating the beamforming codebook using the feedback to produce the updated beamforming codebook.

Aspect 11: The method of aspect 10, wherein the feedback comprises one or more co-phasing factors, each indicating a respective phase deviation across the first antenna array and the second antenna array based upon respective combinations of the one or more uplink reference signals.

Aspect 12: The method of aspect 10, wherein the feedback comprises one or more updated beam weights to produce the updated beamforming codebook.

Aspect 13: The method of any of aspects 1 through 12, wherein the identifying the current foldable state further comprises: calculating a current angular separation between the first tile and the second tile based on a set of sensor data; and identifying the current foldable state based on the current angular separation.

Aspect 14: An apparatus at a UE comprising one or more memories and one or processors coupled to the one or more memories, the one or more processors configured to perform a method of any of aspects 1 through 13.

Aspect 15: An apparatus configured for wireless communication at a user equipment (UE) comprising means for performing a method of any of aspects 1 through 13.

Aspect 16: A non-transitory computer-readable medium having stored therein instructions executable by one or more processors of a user equipment (UE) to perform a method of any one of aspects 1 through 13.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3-8, 10, and/or 13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus at a user equipment (UE), the apparatus comprising:
a plurality of antenna arrays configured for beamforming, wherein the plurality of antenna arrays comprises a first antenna array and a second antenna array coupled to the first antenna array;
one or more memories; and
one or more processors coupled to the one or more memories, wherein the one or more processors are configured to cause the UE to:
identify a current foldable state of a plurality of foldable states of the UE, wherein each of the plurality of foldable states is defined by a respective angular separation between a first tile of the UE and a second tile of the UE, wherein the first tile comprises the first antenna array and the second tile comprises the second antenna array;
update a beamforming codebook of a plurality of beamforming codebooks of the UE based on the current foldable state to produce an updated beamforming codebook, wherein each of the plurality of beamforming codebooks is associated with a respective configured foldable state of the plurality of foldable states; and
communicate with a network entity using the updated beamforming codebook.

2. The apparatus of claim 1, wherein the one or more processors are further configured to cause the UE to:
compare the current foldable state to each of the respective configured foldable states associated with the plurality of beamforming codebooks; and
update the beamforming codebook in response to the current foldable state being different than any of the configured foldable states.

3. The apparatus of claim 1, wherein the one or more processors are further configured to cause the UE to:
select a first beamforming codebook of the plurality of beamforming codebooks, wherein the first beamforming codebook is associated with a first configured foldable state;
analyze a current performance of the first beamforming codebook for the current foldable state; and
update the first beamforming codebook to produce the updated beamforming codebook for the current foldable state in response to the current performance failing to meet an expected performance.

4. The apparatus of claim 3, wherein the angular separation associated with the first configured foldable state is nearest to the angular separation associated with the current foldable state among each of the plurality of beamforming codebooks.

5. The apparatus of claim 3, wherein the first beamforming codebook comprises a first set of beam weights associated with a respective predetermined set of beam directions from each of the first antenna array and the second antenna array and wherein the one or more processors are further configured to cause the UE to:
analyze the current performance utilizing the first set of beam weights.

6. The apparatus of claim 3, wherein the one or more processors are further configured to cause the UE to:
determine a set of one or more co-phasing factors, each indicating a respective phase deviation across the first antenna array and the second antenna array based on the current foldable state; and
modify one or more beam weights in the first beamforming codebook using the set of one or more co-phasing factors to produce the updated beamforming codebook.

7. The apparatus of claim 1, wherein the one or more processors are further configured to cause the UE to:
transmit a request for a codebook update to the network entity.

8. The apparatus of claim 7, wherein the one or more processors are further configured to cause the UE to:
receive a grant of at least one of one or more downlink reference signals or one or more uplink reference signals from the network entity;
communicate the at least one of the one or more downlink reference signals or the one or more uplink reference signals with the network entity; and
update the beamforming codebook based on communication of the at least one of the one or more downlink reference signals or the one or more uplink reference signals.

9. The apparatus of claim 8, wherein the one or more processors are further configured to cause the UE to:
re-calibrate the updated beamforming codebook for uplink-downlink radio frequency circuit level mismatches.

10. The apparatus of claim 8, wherein the one or more processors are further configured to cause the UE to:
transmit the one or more uplink reference signals to the network entity;
receive feedback from the network entity based on the one or more uplink reference signals; and
update the beamforming codebook using the feedback to produce the updated beamforming codebook.

11. The apparatus of claim 10, wherein the feedback comprises one or more co-phasing factors, each indicating a respective phase deviation across the first antenna array and the second antenna array based upon respective combinations of the one or more uplink reference signals.

12. The apparatus of claim 10, wherein the feedback comprises one or more updated beam weights to produce the updated beamforming codebook.

13. The apparatus of claim 1, wherein the one or more processors are further configured to cause the UE to:
calculate a current angular separation between the first tile and the second tile based on a set of sensor data; and
identify the current foldable state based on the current angular separation.

14. A method operable at a user equipment (UE), the method comprising:
identifying a current foldable state of a plurality of foldable states of the UE, wherein each of the plurality of foldable states is defined by a respective angular separation between a first tile of the UE and a second tile of the UE, wherein the first tile comprises a first antenna array and the second tile comprises a second antenna array coupled to the first antenna array, wherein the first antenna array and the second antenna array are configured for beamforming;
updating a beamforming codebook of a plurality of beamforming codebooks of the UE based on the current foldable state to produce an updated beamforming codebook, wherein each of the plurality of beamforming codebooks is associated with a respective configured foldable state of the plurality of foldable states; and
communicating with a network entity using the updated beamforming codebook.

15. The method of claim 14, wherein the updating the beamforming codebook further comprises:
comparing the current foldable state to each of the respective configured foldable states associated with the plurality of beamforming codebooks; and
updating the beamforming codebook in response to the current foldable state being different than any of the configured foldable states.

16. The method of claim 14, wherein the updating the beamforming codebook further comprises:
selecting a first beamforming codebook of the plurality of beamforming codebooks, wherein the first beamforming codebook is associated with a first configured foldable state;
analyzing a current performance of the first beamforming codebook for the current foldable state; and
updating the first beamforming codebook to produce the updated beamforming codebook for the current foldable state in response to the current performance failing to meet an expected performance.

17. The method of claim 16, wherein the angular separation associated with the first configured foldable state is nearest to the angular separation associated with the current foldable state among each of the plurality of beamforming codebooks.

18. The method of claim 16, wherein the first beamforming codebook comprises a first set of beam weights associated with a respective predetermined set of beam directions from each of the first antenna array and the second antenna array and wherein the analyzing the current performance further comprises:
analyzing the current performance utilizing the first set of beam weights.

19. The method of claim 16, wherein the updating the first beamforming codebook further comprises:
determining a set of one or more co-phasing factors, each indicating a respective phase deviation across the first antenna array and the second antenna array based on the current foldable state; and
modifying one or more beam weights in the first beamforming codebook using the set of one or more co-phasing factors to produce the updated beamforming codebook.

20. An apparatus, comprising:
means for identifying a current foldable state of a plurality of foldable states of the UE, wherein each of the plurality of foldable states is defined by a respective angular separation between a first tile of the UE and a second tile of the UE, wherein the first tile comprises a first antenna array and the second tile comprises a second antenna array coupled to the first antenna array, wherein the first antenna array and the second antenna array are configured for beamforming;
means for updating a beamforming codebook of a plurality of beamforming codebooks of the UE based on the current foldable state to produce an updated beamforming codebook, wherein each of the plurality of beamforming codebooks is associated with a respective configured foldable state of the plurality of foldable states; and
means for communicating with a network entity using the updated beamforming codebook.
